(19) United States
(12) Patent Application Publication
(10) Pub. No.: US 2008/0320170 A1
(43) Pub. Date: Dec. 25, 2008

(54) DATA COMMUNICATION APPARATUS AND DATA COMMUNICATION METHOD

(75) Inventors: Shinichiro Yamauchi, Osaka (JP); Akio Takeuchi, Osaka (JP); Takayoshi Koyama, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/144,753

(22) Filed: Jun. 24, 2008

(30) Foreign Application Priority Data
Jun. 25, 2007 (JP) 2007-166990

(51) Int. Cl. G06F 15/16

(52) U.S. Cl. 709/247

(57) ABSTRACT

The present invention provides a data communication apparatus for solving the following problem. When generating coded frames of multiple data streams, in the case where there is a bias in code amount of the generated coded frame, the communication apparatus is instantaneously overloaded, causing packet losses.

The network cameral terminal which is the data communication apparatus includes a sensor unit that takes images or audio information, a compression unit that compression-codes the image or the audio signal and generates coded frames (I-frame, P-frame, B-frame and others), a frame control unit that controls types of the coded frame generated by the compression unit using a generation table held in a generation table holding unit, and a communication unit that transmits the coded frames to multiple communication terminals on the network in parallel.

### BACKGROUND OF THE INVENTION

(1) Field of the Invention

The present invention relates to a data communication apparatus and data communication method for communicating a compression-coded image or audio signal in real-time using Internet Protocol (IP) conversion processing technology.

(2) Description of the Related Art

In recent years, the digital data including images and audio information has been generally transmitted using network lines. These images and audio information are used for various purposes, and many of them are used for monitoring and observation. A network camera terminal is a combination of a camera, an image processor and a network communication apparatus, and the user can browse images and audio in a remote location by accessing the apparatuses installed in a place where the user would like to browse the images and audio.

FIG. 1 is a reference diagram showing an exemplary configuration of the conventional network camera terminal 101. Image data transmission by the network camera terminal 101 is described with reference to FIG. 1. The network camera terminal 101 includes: the sensor unit 102 to which image information is inputted; the Y/C unit 103 that performs Y/C process to the image loaded from the sensor unit 102; the compression unit 104 that compression-codes the Y/C data and generates coded frames; and the communication unit 105 that packetizes the coded frames and communicates the packetized coded frames. Types of the coded frames are broadly divided into the first type and the second type. I-frames belong to the first type and P-frames and B-frames belong to the second type. The code amount of the coded frame of the first type is larger than the code amount of the coded frame of the second type.

First, the image information is inputted to the sensor unit 102. The sensor unit 102 digitally converts the image or the audio information and transmits the converted data to the Y/C unit 103. The Y/C unit 103 Y/C processes the received data and resizes the data to a size such as VGA or QVGA. The compression unit 104 receives data from the Y/C unit 103, performs compression coding such as MPEG, and generates the coded frames. The communication unit 105 receives the coded frames, and transmits the coded frames to multiple communication partners 106 via a network such as the Wide Area Network (WAN) or the Local Area Network (LAN).

In FIG. 1, the sizes of the image data transmitted to the communication terminals 106 from the network camera terminal 101 via the network are, for example, Video Graphics Array (VGA: high resolution image mainly used for personal computers), Quarter VGA (QVGA: low resolution image that is a quarter of VGA in size and is mainly used for PDAs and mobile phones), and Quarter Quarter VGA (QQVGA: low resolution image that is a quarter of quarter VGA, and is lower in resolution than the images used for mobile phones).

The compression-coded frames coded in MPEG includes, for example, I-frame that can be decoded with its own data, P-frame that is coded using forward prediction of inter prediction, and B-frame that is coded using bi-directional prediction of inter prediction. There is a difference in code amount among I-frame, P-frame, and B-frame. More specifically, general ratio of code amount of the I-frame and the P-frame or the B-frame is 3 to 1. Thus, in a frame period where I-frame is generated, the code amount sent by the network locally increases, and exceeds average transmission code amount. Furthermore, in the case where multiple coded frames are generated from one image or audio signal and transmitted in parallel, when I-frames are simultaneously generated in the same frame period, the code amount to be transmitted instantaneously increases, and the code amount exceeds the bandwidth that a network can transmit as a result.

FIG. 2 is a reference diagram that shows bias of code amount when three data streams #1, #2, and #3 are simultaneously distributed to multiple communication terminals.

In this case, transmission from the network camera is performed in the same manner as the process described in FIG. 1, and is performed every frame cycle, that is, 33 ms. However, when the frame rate varies, the process is performed every 33 ms×N (N=1, 2, 3 . . . ) cycle. For example, in the case of 30 fps, the cycle is 33 ms, 66 ms in the case of 15 fps, and 99 ms in the case of 10 fps.

Note that in this specification, the description is made assuming that the frame rate is 30 fps and the MPEG coded frames includes I-frames that can be decoded with their own data and P-frames that are coded using forward prediction of inter prediction. However, variation in the frame rate and addition of B-frames does not cause any problem.

In FIG. 2, I-frames 201, 202, and 203 are generated within the same frame period in three different data streams. Thus, intra coding for the I-frames are overlapped, coded frames that exceeds transmission capacity of the communication apparatus is generated, code amount to be transmitted increases in the period in which an I-frame is generated, causing the overload 204. Furthermore, transmission process occurs during the minimum frame period 33 ms for transmitting the overload 204. When the transmission process is not completed in the minimum frame period 33 ms, the coded frames cannot be sent according to the frame rate determined in each data stream.

Furthermore, it is necessary to transmit coded frames in each data stream within the predetermined time period according to the predetermined frame rate. When the coded frames are not sent within the predetermined time period, a so-called fallen frame is generated, and the reception side 106 is unable to continuously reproduce the moving picture. In this case, it negatively affects the quality of reproduced image. For example, it is serious in the case of the MPEG coding. When an I-frame is missing, no image is reproduced at all until next I-frame arrives. This is because I-frame is standard information of reproduction information. Furthermore, when a P-frame is missing, an accurate image is not reproduced due to lack of difference information.

Thus, it takes time to transmit coded information with large code amount. In order to transmit the moving picture data without generating a fallen frame, each code amount of the generated coded frames need to be controlled.

Furthermore, compression-coding using inter-frame prediction such as the MPEG standard, a problem that the generated code amount largely varies and instantaneously exceeds the bandwidth that a network can transmit arises. More specifically, in a network camera terminal, multiple compression coded frames are generated from one video source and the variation in generated code amount further increases when the multiple compression coded frames are delivered simultaneously.

In addition, a method for controlling generation timing of the coded frames has been known as a technique for controlling the coded amount that is the problem above (for example, see Japanese Unexamined Patent Application Publication 2004-140651).

### SUMMARY OF THE INVENTION

However, the invention disclosed in Japanese Unexamined Patent Application Publication 2004-140651 has two problems. More specifically, the first problem is that the generation of I-frames cannot be controlled in any frame period. In Japanese Unexamined Patent Application Publication 2004-140651, the starting timing of image and audio signal is shifted per frame, so that the generation timing of I-frames does not overlap within the same frame period. Thus, it is presumed that the interval of I-frames is constant, and generation of I-frames cannot be controlled in any frame period. In the MPEG standard, bit rate and frame rate, and the interval of I-frames are not dependent, and the interval can be arbitrarily set.

The second problem is that the method disclosed in Japanese Unexamined Patent Application Publication 2004-140651 requires a configuration with multiple compression units. In Japanese Unexamined Patent Application Publication 2004-140651, synchronization signal is detected from the inputted image signal, and multiple different data streams are generated in multiple compression units. Thus, it is presupposed that the data communication apparatus includes multiple compression units, which increases the cost for the data communication apparatus. Note that a network camera for general consumers or business only includes one compression unit for cost reduction, and uses the compression unit in time-sharing for generating multiple different data streams in the same frame period.

The present invention has been conceived in view of the problems above, and the object of the present invention is to provide a data communication apparatus that transmits multiple data streams to multiple communication terminals via network in parallel, and that can appropriately prevent communication delay from occurring while maintaining controllability of the generation of I-frame in arbitrary frame periods.

In order to solve the above problem, the data communication apparatus according to the present invention is a data communication apparatus that generates coded frames from an inputted image or audio signal through compression coding and communicates data streams to communication terminals in parallel through a network, the data streams including the generated coded frames, the data communication apparatus including: a sensor unit configured to take image or audio information; a compression unit configured to compression-code the image or the audio signal that has been taken by the sensor unit and to generate coded frames for each frame period; a frame control unit configured to control types of the coded frames generated by the compression unit, the types of the coded frames including a first type and a second type, and the coded frame of the first type having larger code amount than the coded frame of the second type; and a communication unit configured to communicate the coded frames compression-coded by the compression unit to the communication terminals in parallel through the network, in which the frame control unit is configured to control the types of the coded frames respectively corresponding to data streams, such that the coded frames of the first type are not generated within a same frame period.

With this configuration that includes one compression unit, I-frames are generated in different frame periods in three data streams by the control of the frame control unit. Thus the code amount to be transmitted decreases and it is possible to reduce the bias that is locally generated, and smooth the code amount.

Furthermore, the frame control unit of the data communication apparatus according to the present invention includes a generation table holding unit configured to store a generation table indicating a combination patterns of the types of coded frames generated by the compression unit, and the frame control unit is configured to control, according to the combination patterns the types of coded frames respectively corresponding to the data streams, such that the coded frames of the first type with large code amount are not generated within the same frame period.

With this configuration, the frame control unit can control the generation of the I-frames using the generation table, and perform control such that the frames of the first type are not generated simultaneously.

Furthermore, the frame control unit according to the present invention includes decrement counters respectively corresponding to the data streams, and the frame control unit is configured to control the types of the coded frames each of which corresponds to each data stream using counter values of the decrement counter for modifying the generation rate of the coded frames.

Furthermore, the frame control unit according to the present invention is configured to control the types of the coded streams respectively corresponding to the data stream such that the coded frames of the first type are not generated within the same frame period by adjusting initial values of the decrement counters for each data stream so that the initial values are not to be equal, or by adding or subtracting counter values when the counter values of the decrement counters are equal to one another.

With these configurations, when the data streams are communicated in parallel using the decrement counter units, it is possible to perform control such that the coded frames of the first type are not generated simultaneously.

Furthermore, the data communication apparatus according to the present invention further includes a bandwidth monitoring unit configured to monitor a communication bandwidth of the communication unit, in which the bandwidth monitoring unit is configured to notify the frame control unit when the communication bandwidth exceeds a predetermined amount, and the frame control unit is configured to perform control such that a coded frame of the second type is generated when the frame control unit has received the notification from the bandwidth monitoring unit.

Furthermore, the data communication apparatus according to the present invention further includes a CPU load monitoring unit configured to monitor a CPU load rate, in which the CPU load monitoring unit is configured to notify the frame control unit when the CPU load rate exceeds a predetermined rate, and the frame control unit is configured to perform control such that a coded code of the second type is generated when the frame control unit has received the notification from the CPU load monitoring unit.

Furthermore, the data communication apparatus according to the present invention further includes a code amount monitoring unit configured to monitor code amount of the generated coded frames, in which the code amount monitoring unit is configured to notify the frame control unit when the code amount of the generated coded frames exceeds a predetermined amount, and the frame control unit is configured to perform control such that a coded frame of a type with small code amount is generated when the frame control unit receives the notification.

With these configurations, when the code amount of the generated coded frame exceed the predetermined amount, the bandwidth monitoring unit, the CPU load monitoring unit, or the code amount monitoring unit notify the frame control unit, and the frame control unit can perform control so that the coded frame of the second type is generated when receiving the notification.

It should be noted that the present invention may be implemented, not only as the data communication apparatus, but also a data communication method including the characteristic components of the data communication apparatuses, or a program that causes a computer to execute these steps. Furthermore, it is needless to say that such a program may be distributed via a recording medium such as CD-ROM, or transmission media such as the Internet.

The data communication apparatus according to the present invention can reduce the locally generated bias in code amount appropriately, and can smooth the code amount.

Furthermore, with this configuration, the generation of I-frames can be controlled within any frame period, and multiple compression units are not necessary.

### FURTHER INFORMATION ABOUT TECHNICAL BACKGROUND TO THIS APPLICATION

The disclosure of Japanese Patent Application No. 2007-166990 filed on Jun. 25, 2007 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a reference diagram showing an exemplary configuration of the conventional network camera terminal;

FIG. 2 is a reference diagram that shows distribution of code amount when three data streams #1, #2, and #3 are simultaneously distributed to multiple communication terminals;

FIG. 3 is a functional block diagram showing the configuration of the network camera terminal according to the first embodiment;

FIG. 4 is a reference diagram showing smoothing in code amount in the three data streams transmitted from the network camera terminal according to the first embodiment;

FIG. 5 is a reference diagram showing a generation table of a coded frame;

FIG. 6 is a flowchart showing the operation order of the network camera terminal according to the first embodiment;

FIG. 7 is an explanatory diagram of time-sharing process of the respective processing units in the network camera terminal according to the first embodiment;

FIG. 8 is a functional block diagram showing the configuration of the network camera terminal according to the second embodiment;

FIG. 9 is a flowchart showing the operation order of the network camera terminal according to the second embodiment;

FIG. 10 is a functional block diagram showing the configuration of the network camera terminal according to the third embodiment;

FIG. 11 is a flowchart showing the operation order of the bandwidth monitoring unit in the network camera terminal according to the third embodiment;

FIG. 12 is a functional block diagram showing the configuration of the network camera terminal according to the fourth embodiment;

FIG. 13 is a flowchart showing the operation order of the CPU load monitoring unit in the network camera terminal according to the fourth embodiment;

FIG. 14 is a functional block diagram showing the configuration of the network camera terminal according to the fifth embodiment;

FIG. 15 is a flowchart showing the operation order of the code amount monitoring unit in the network camera terminal according to the fifth embodiment;

FIG. 16 is a functional block diagram showing the configuration of the network camera terminal according to the sixth embodiment;

FIG. 17 is a flowchart showing the operation order of the frame pattern monitoring unit in the network camera terminal according to the sixth embodiment;

FIG. 18 is a functional block diagram showing the configuration of the network camera terminal according to the seventh embodiment;

FIG. 19 is a flowchart showing the operation order of the counters in the network camera terminal according to the seventh embodiment;

FIG. 20 is a flowchart showing the operation order of the network camera terminal when the communication bandwidth, the CPU load rate, and code amount are monitored in combination;

FIG. 21 is a functional block diagram showing the configuration of the network camera terminal according to the eighth embodiment;

FIG. 22 is a functional block diagram showing the configuration of the network camera terminal according to the ninth embodiment; and

FIG. 23 is a functional block diagram showing the configuration of the network camera terminal according to the tenth embodiment.

### DESCRIPTION OF THE PREFERRED EMBODIMENT(S)

Embodiments of the data communication apparatus according to the present invention is hereafter described with reference to the drawings.

### First Embodiment

The first embodiment of the data communication apparatus according to the present invention is hereafter described with reference to the drawings.

Note that the network camera terminal according to the first embodiment is characterized in that the frame control unit generates I-frames corresponding to each stream at the I-frame generation rate described in the generation table which has been held in the frame control unit in advance. In addition, the network camera terminal in the description of the embodiments corresponds to the data communication apparatus in the Claims.

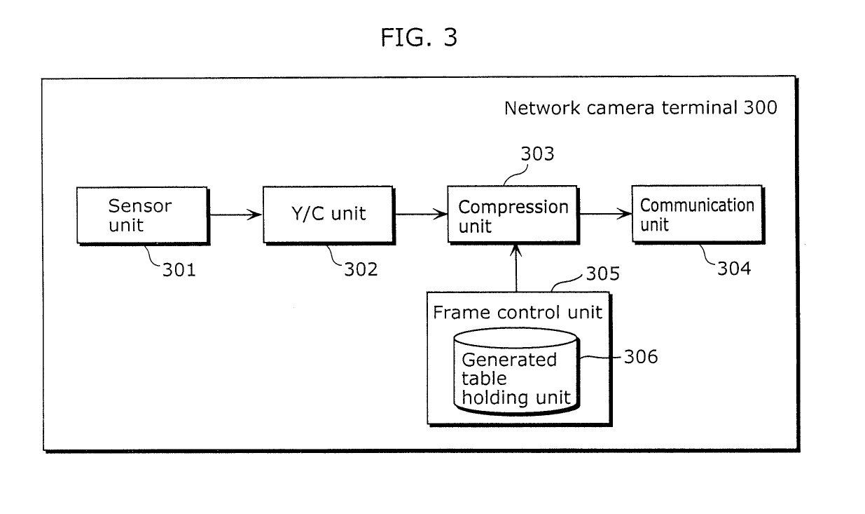

FIG. 3 is a functional block diagram showing the configuration of the network camera terminal according to the first embodiment.

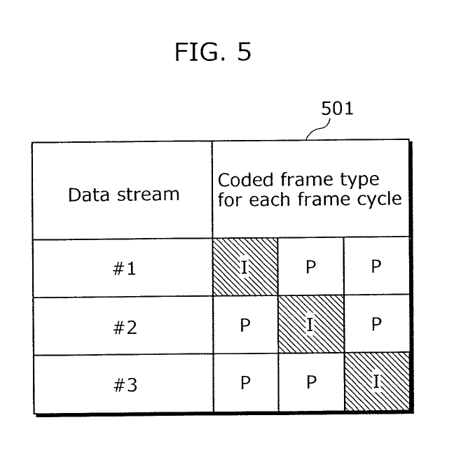

The network camera terminal 300 according to the first embodiment includes: the sensor unit 301 to which image information is inputted; the Y/C unit 302 which perform Y/C process to the image loaded from the sensor unit 301; the compression unit 303 which compression-codes the Y/C data and generates coded frames, the communication unit 304 which packetize the coded frames and communicates the packetized data; and the frame control unit 305 which controls the types of the coded frames generated in the compression unit 303. In addition, the frame control unit 305 includes the generated table holding unit 306 which holds the generation table 501 that indicates patterns of coded table generated in FIG. 5 which is to be described later.

Here, as shown in FIG. 5, the generation table 501 includes combination patterns of the coded frames that are generated by the compression unit in multiple data streams within the same frame period. The I-frame occurrence rate may be actively modified by actively rewriting the generation table 501. Furthermore, the generation table 501 may be implemented as software or hardware.

Note that the configuration of the network camera terminal 300 includes a memory that stores process data, a Memory Control Unit (MCU) that mediates access control to the memory, a flash memory in which execution programs are provided, a CPU which controls the execution program, and internal buses that connects the respective processing units. However, the description for those components is omitted for the simplicity of the explanation.

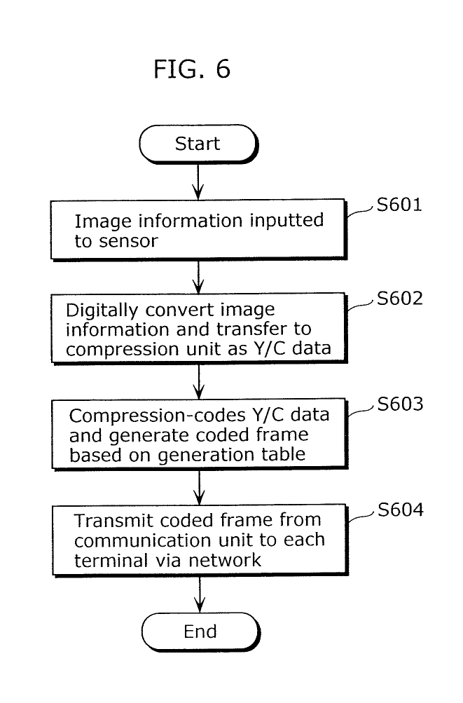

The operation process of the network camera terminal 300 according to the first embodiment is hereafter described. FIG. 6 is a flowchart showing the operation order of the network camera terminal 300 according to the first embodiment.

First, the image information is inputted to the sensor unit 301 (S601). The sensor unit 301 digitally converts the image information and transmits the converted information to the Y/C unit 302. The Y/C unit 302 reads the digital data transmitted by the sensor unit 301, and resizes the data after the Y/C process, and transmits the data to the compression unit 303 as the Y/C data (S602).

Next, the compression unit 303 receives the Y/C data from the Y/C unit 302, performs compression-coding such as MPEG, generates the coded frames based on the generation table 501, and transmits the coded frames to the communication unit 304 (S603). Here, the coded frames are generated according to the pattern in the generation table 501. The generation table 501 generates patterns in such a manner that an I-frame having a large code amount is not generated in multiple data streams within the same frame period.

Next, the communication unit 304 performs process such as IP protocol process, and transmits the coded frames suitable for an image resolution of each communication terminals to communication terminals such as a personal computer, a PDA, and a mobile phone and others via the Wide Area Network (WAN) or the Local Area Network (LAN) (S604).

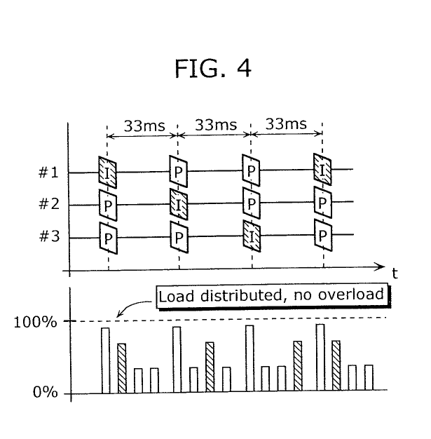

Note that FIG. 4 is a reference diagram showing smoothing in code amount in the three data streams transmitted from the network camera terminal 300 according to the first embodiment. As shown in the diagram, I-frames are generated in different frame periods in three data streams. It is effective for appropriately reducing code amount to be transmitted appropriately, reducing bias of code amount that is generated locally, and smoothing the code amount.

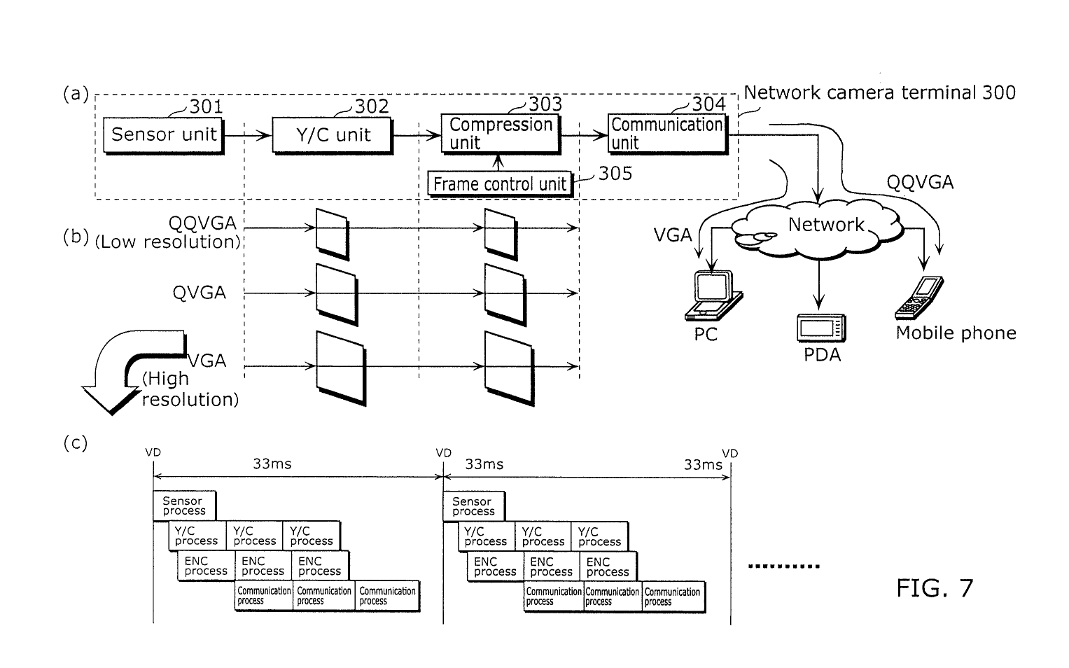

In addition, FIG. 7 illustrates an explanatory diagram of time-sharing process of the respective processing units in the network camera terminal 300 according to the first embodiment. As shown in FIG. 7, preventing simultaneous generation of coded frames having a large amount of codes using the generation table, the sensor unit 301, the Y/C unit 302, the compression unit 303, the communication unit 304, and the frame control unit 305 is appropriately performed in time-sharing. This appropriately prevents communication delay from occurring.

As described above, the network camera terminal according to the first embodiment includes one compression unit, and can control generation timing of I-frames generated in each of the streams using the generation table held in the frame control unit. Thus, it is possible to easily reduce the bias that is locally generated in coding amount and realize smooth code amount in a data communication apparatus that transmits data streams on the network in parallel.

### Second Embodiment

The second embodiment according to the present invention is hereafter described with reference to the drawings.

Note that the network camera terminal according to the second terminal is characterized in that, unlike the network camera terminal in the first embodiment with which the generation rate of I-frame is fixed using the generation table, generation of I-frames in multiple streams are controlled not to overlap each other using decrement counters included in the frame control unit when the generation rates of I-frames vary.

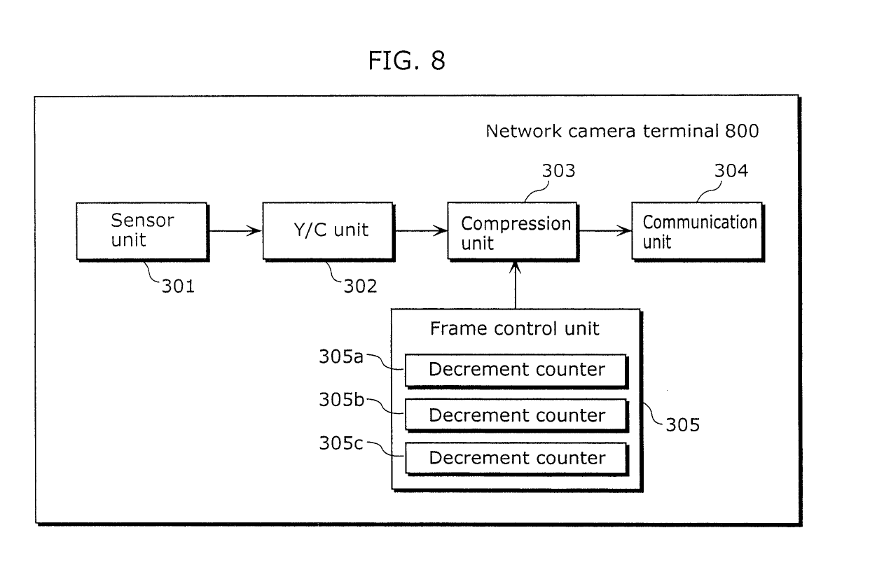

FIG. 8 is a functional block diagram showing the configuration of the network camera terminal 800 according to the second embodiment.

The network camera terminal 800 according to the second embodiment includes, in addition to the component in the first embodiment, decrement counters 305a to 305c for counting the number of frames generated in each of the three streams in the frame control unit.
The decrement counter 305a corresponds to one stream in multiple streams, takes generation cycle of I-frames in corresponding stream as an initial value, and performs decrementing for each frame period. For example, when the generation cycle of I-frame is every 5 frames, the initial value is 5, and the count value 1 indicates a timing frame period in which an I-frame should be generated.
The decrement counters 305b and 305c have the same configuration as the decrement counter 305a except that they correspond to different streams.

The operation process of the network camera terminal according to the first embodiment is hereafter described. First, the image information is inputted to the sensor unit 301. The sensor unit 301 digitally converts the image information and transmits the converted information to the Y/C unit 302. The Y/C unit 302 reads the digital data transmitted by the sensor unit 301, and resizes the data after the Y/C process, and transmits the data to the compression unit 303 as the Y/C data.

Next, the compression unit 303 receives the Y/C data from the Y/C unit 302, performs compression-coding such as MPEG, generates and controls the coded frames using the decrement counters 305a to 305c in the frame control unit 305, and transfers the coded frames to the communication unit 304. The communication unit 304 transmits the received coded frames to the communication partner via the network.

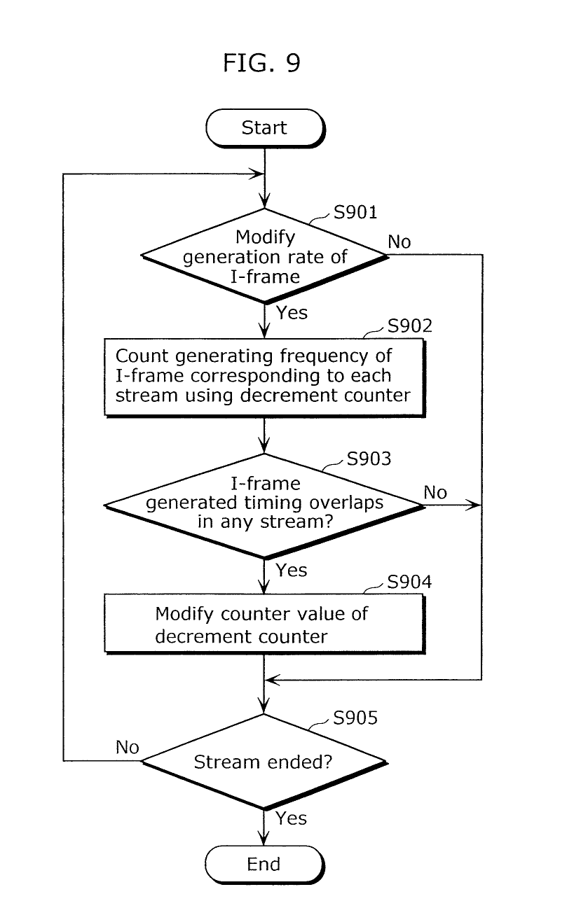

FIG. 9 shows the flowchart indicating operation order when controlling the generation timing of the I-frames in each of the streams using the decrement counter in the network camera terminal according to the second embodiment.

First, it is confirmed whether the generation rate of I-frames in each stream is modified or not (S901).

Next, in the decrement counters 305a to 305c, decrement counting that indicates I-frame generation timing is started for each stream (S902). For example, when one I-frame is inserted every 30 frames at 30 fps, decrement counting from 30 to 1 is performed in one second.

Furthermore, it is judged whether the generation timing of an I-frame overlaps or not by an overlap of counter values counted by the decrement counters 305a to 305c, and when there is the overlap (Yes in S903), the counter value of one of the decrement counters are modified (S904) so as to prevent overlapped I-frames in the respective streams. Note that as the modification method, modification of a counter initial value so that the initial values do not overlap, or adding 1 to one of the decrement counter values.

The process is performed until the stream ends (S905). As described above, the network camera terminal according to the second embodiment includes decrement counters that counts the generation of I-frames in each frame in the frame control unit. This prevents overlap of the generation timing of the I-frames in each stream appropriately, facilitates reducing bias of code amount that is generated locally, and realizes smoothing of the code amount.

Note that, in the second embodiment, an example using the decrement count values of the decrement counters 305a to 305c. However, increment counter or a timer or a counter that generates set cycles may also be used.

### Third Embodiment

The third embodiment according to the present invention is hereafter described with reference to the drawings.

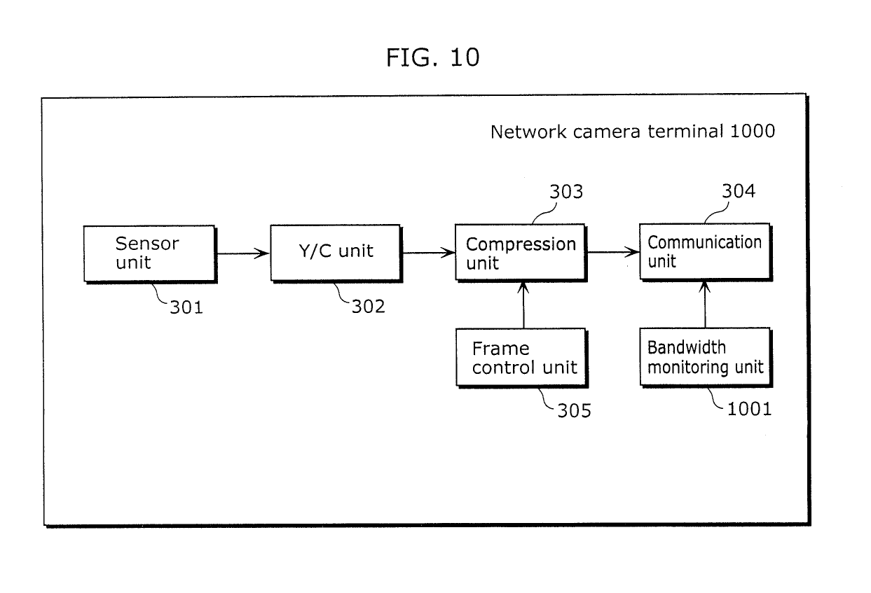

FIG. 10 is a functional block diagram showing the configuration of the network camera terminal 1000 according to the third embodiment, and the configuration of the network camera terminal 1000 is characterized by, in addition to the components shown in the first embodiment, the bandwidth monitoring unit 1001 that monitors the communication bandwidth of the communication unit 304.

The operation process of the network camera terminal 1000 according to the third embodiment is hereafter described.

First, the image information is inputted to the sensor unit 301. The sensor unit 301 digitally converts the image information and transmits the converted information to the Y/C unit 302. The Y/C unit 302 reads the digital data transmitted by the sensor unit 301, and resizes the data after the Y/C process, and transmits the data to the compression unit 303 as the Y/C data.

Next, the compression unit 303 receives the Y/C data from the Y/C unit 302, performs compression-coding such as MPEG, generates the coded frames, and transmits the coded frames to the communication unit 304. The communication unit 304 transmits the received coded frames to the communication partner via the network.

Here, the bandwidth monitoring unit 1001 monitors the communication bandwidth of the communication unit 304. The bandwidth monitoring unit 1001 prevents the communication unit from exceeding the communication bandwidth when the communication is jammed for some reason and the communication bandwidth is narrow.

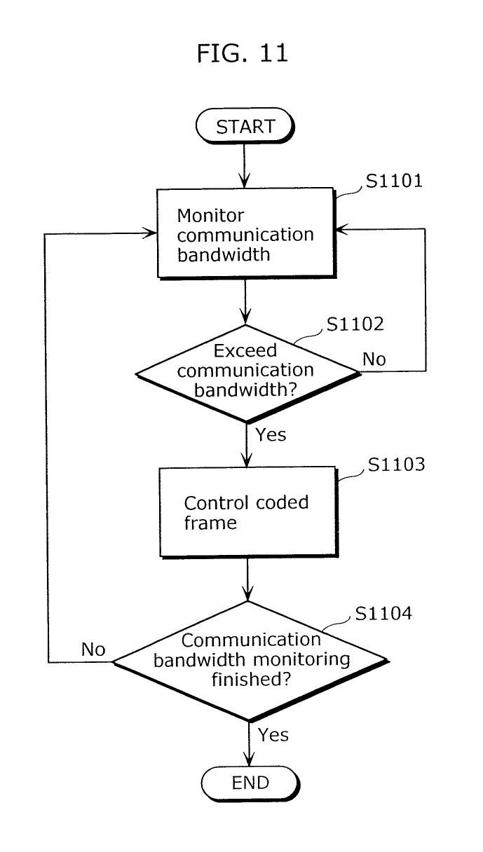

The process flow for communication bandwidth monitoring in the bandwidth monitoring unit 1001 is described with reference to FIG. 11.

First, when the monitoring of the communication bandwidth starts, the bandwidth monitoring unit 1001 start bandwidth monitoring of the communication unit 304 (S1101). When it is judged that the communication bandwidth that has been monitored exceeds a fixed value (Yes in S1102), the frame control unit 305 is notified, and the frame control unit 305 controls the compression unit 303 to generate the coded frames having small code amount (S1103). Note that the control method in the bandwidth monitoring unit 1001 is to control the generation timing of the I-frame, and may be the method using the generation table in the frame control unit 305 as described in the first embodiment, or may be the method using the decrement counters as described in the second embodiment.

Next, the termination of monitoring of the communication bandwidth is checked (S1104), and when the monitoring of the communication bandwidth continues (No in S1104), the monitoring of the communication bandwidth continues. On the other hand, when the communication bandwidth monitoring is terminated (Yes in S1104), monitoring process is finished.

As described above, the network camera terminal according to the third embodiment can achieve the same effects achieved in the first embodiment, namely, facilitating reduction of bias of code amount that is generated locally, and realizing the smoothing of the code amount. Furthermore, a unit and a method for monitoring the communication width that could inhibit communication performance of the communication unit 304 in the bandwidth monitoring unit 1101, and for performing autonomous feedback control. Thus, use of the data communication apparatus according to the third embodiment enables easy reduction of bias of code amount that is generated locally by the autonomous feed back control, and realizing the smoothing of the code amount, in a data communication apparatus that transmits multiple data streams in parallel on the network.

### Fourth Embodiment

The fourth embodiment according to the present invention is hereafter described with reference to the drawings.

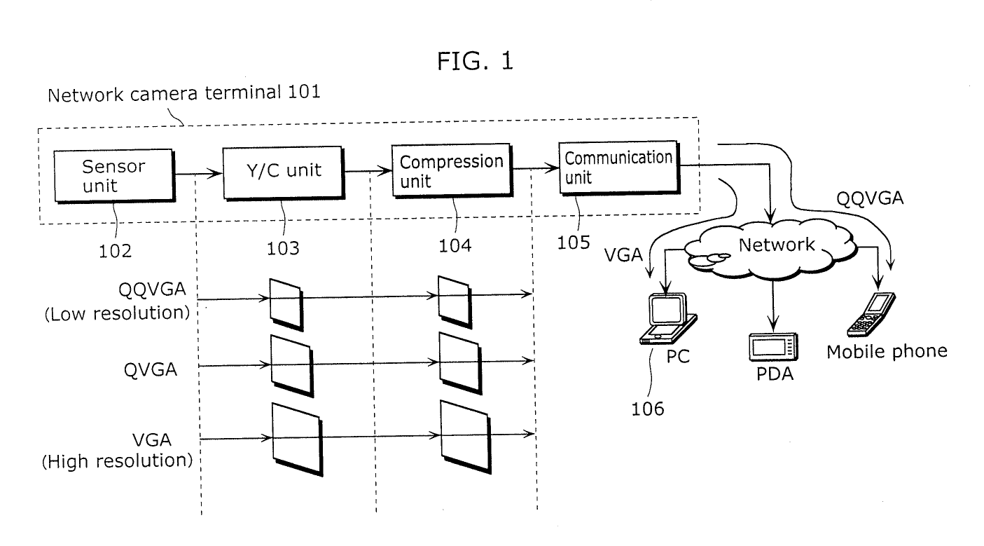

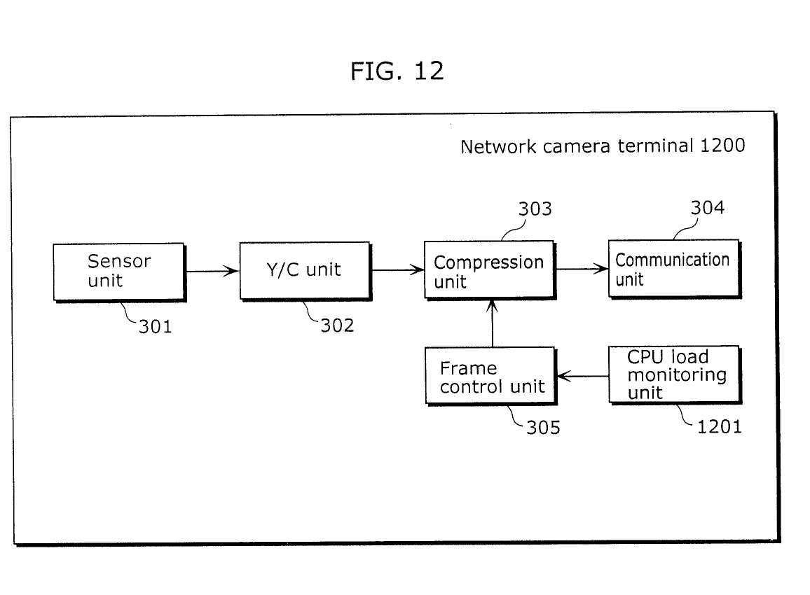

FIG. 12 is a functional block diagram showing the configuration of the network camera terminal 1200 according to the fourth embodiment, and is characterized by the CPU load monitoring unit 1201 that monitors CPU load rate in addition to the configuration described in FIG. 1. Here, the CPU performs the function of, at least a part of the compression unit 303 or the communication unit 304 in the network camera terminal 1200.

The operation process of the network camera terminal 1200 according to the fourth embodiment is hereafter described.

First, the image information is inputted to the sensor unit 301. The sensor unit 301 digitally converts the image information and transmits the converted information to the Y/C unit 302. The Y/C unit 302 reads the digital data transmitted by the sensor unit 301, resizes the data after the Y/C process, and transmits the data to the compression unit 303 as the Y/C data. Next, the compression unit 303 receives the Y/C data from the Y/C unit 302, performs compression-coding such as MPEG, generates the coded frames, and transmits the coded frames to the communication unit 304. The communication unit 304 transmits the received coded frames to the communication partner via the network.

Here, the CPU load monitoring unit 1201 monitors the CPU load rate. For example, when the load is large on camera processing and the CPU utilization rate is high, the code amount that can be transmitted by the communication unit 304 is smaller because the CPU cannot focus on the communication process. Thus, in the coded frames having large code amount, it is necessary to prevent the code amount from exceeding the code amount that can be communicated via the communication unit 304.

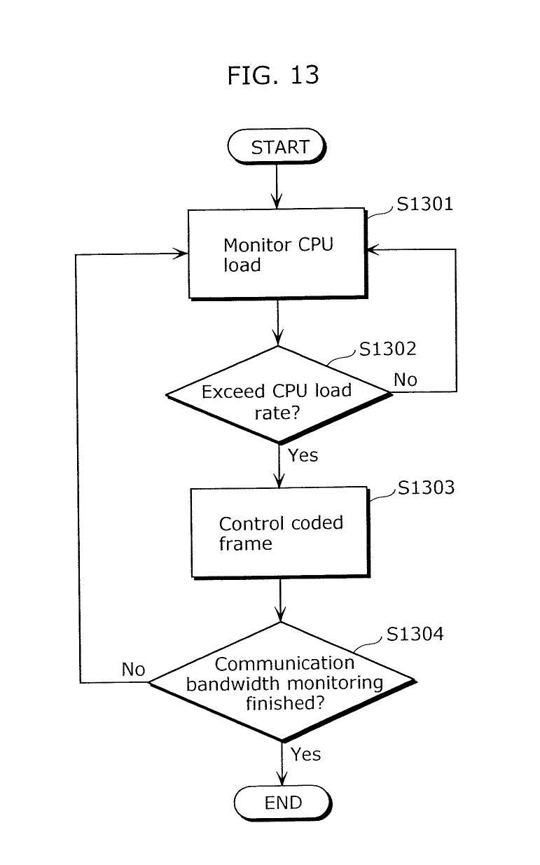

The process flow of communication bandwidth monitoring is described with reference to FIG. 13. When the monitoring of the communication bandwidth starts, the CPU load monitoring unit 1201 starts monitoring of the CPU load (S1301). Note that the load monitoring by the CPU load monitoring unit 1201 is performed, for example, by measuring idle time in the CPU.

Furthermore, when it is judged that the CPU load rate that has been monitored exceeds the fixed utilization rate (Yes in S1302), the frame control unit 305 is notified, and the frame control unit 305 controls the compression unit 303 to generate the coded frames having small code amount (S1303).

Next, when the termination of the CPU load rate monitoring is checked (S1304), and when the monitoring of the CPU load rate continues (No in S1304), monitoring of the CPU load rate (S1301) continues. If the monitoring of the CPU load rate is terminated (Yes in S1304), the monitoring process is terminated.

As described above, the network camera terminal according to the fourth embodiment is effective for easily reducing bias of code amount that is generated locally, and for realizing the smoothing of the code amount, as described in the first embodiment. Furthermore, a unit and a method for monitoring the communication width that could inhibit communication performance of the communication unit 304 in the CPU load monitoring unit 1201, and for performing autonomous feedback control. Thus, use of the data communication apparatus according to the fourth embodiment enables easy reduction of bias of code amount that is generated locally by the autonomous feedback control, and realizing the smoothing of the code amount in a data communication apparatus that transmits multiple data streams in parallel on the network.

### Fifth Embodiment

The fifth embodiment according to the present invention is hereafter described with reference to the drawings.

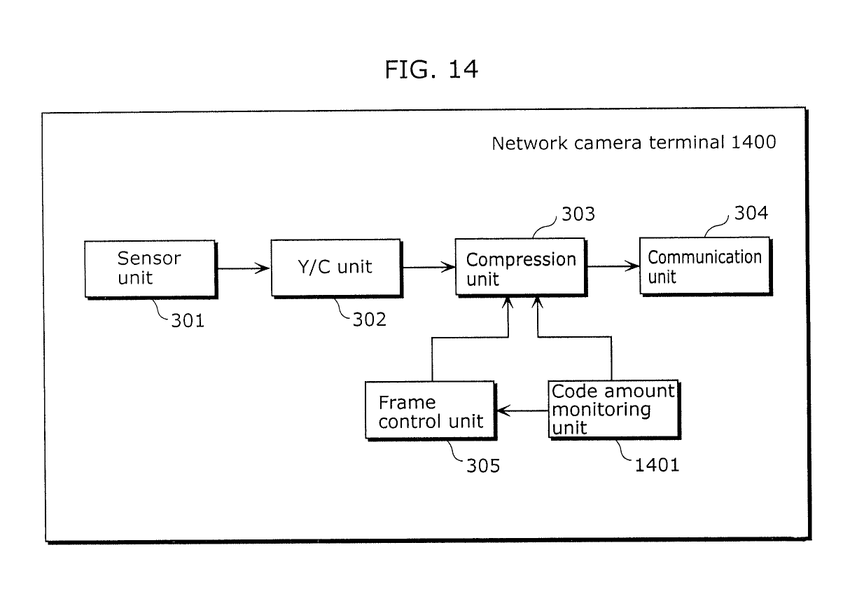

FIG. 14 is a functional block diagram showing the configuration of the network camera terminal 1400 according to the fifth embodiment, and is characterized by the code amount monitoring unit 1401 that monitors code amount of the coded frames generated in the same frame period in addition to the configuration described in FIG. 1.

The operation process of the network camera terminal 1400 according to the fifth embodiment is hereafter described.

First, the image information is inputted to the sensor unit 301. The sensor unit 301 digitally converts the image information and transmits the converted information to the Y/C unit 302. The Y/C unit 302 reads the digital data transmitted by the sensor unit 301, and resizes the data after the Y/C process, and transmits the data to the compression unit 303 as the Y/C data.

Next, the compression unit 303 receives the Y/C data from the Y/C unit 302, performs compression-coding such as MPEG, generates the coded frames, and transmits the coded frames to the communication unit 304. The communication unit 304 performs, for example, IP protocol process on the received coded frames, and transmits the processed coded frames to a communication partner via the network such as the Wide Area Network (WAN) or the Local Area Network (LAN).

Here the code amount monitoring unit 1401 monitors the code amount generated in the same frame period by the compression unit 303. For example, when the subject increases the code amount of the coded frame, the code amount exceeds the amount that can be transmitted by the communication unit 304. Thus, in the coded frames having large code amount, it is necessary to prevent the code amount from exceeding the code amount that can be communicated via the communication unit 304.

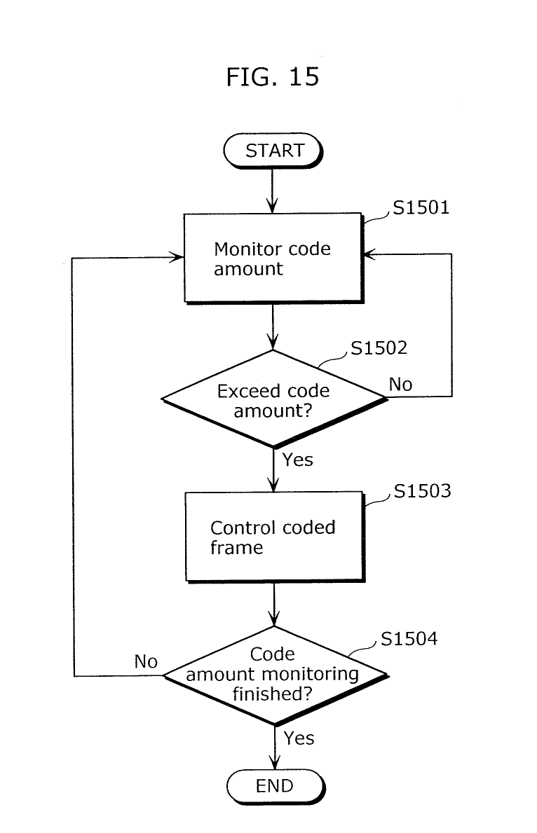

The process flow of the code amount monitoring unit 1401 is described with reference to FIG. 15. First, when the monitoring of the communication bandwidth starts, the code amount monitoring unit 1401 starts monitoring of the code amount in the compression unit 303 (S1501). Note that the code amount monitoring by the code amount monitoring unit 1401 includes, for example, monitoring of code amount in each stream, and monitoring of the number of bits in one frame.

When it is judged that the code amount exceeds a fixed value (Yes in S1502), the frame control unit 305 is notified, and the frame control unit 305 controls the compression unit 303 to generate the coded frames having small code amount (S1503).

Next, the termination of monitoring of the code amount is checked (S1504), and when the monitoring of the code amount continues (No in S1504), processing after monitoring of the code amount (S1501) continues.

On the other hand, when the monitoring of the code amount is terminated (Yes in S1504), the monitoring process is terminated. As described above, the network camera terminal according to the fifth embodiment can achieve the same effects achieved in the first embodiment, namely, facilitating reduction of bias of code amount that is generated locally, and realizing the smoothing of the code amount. Furthermore, a unit and a method for monitoring the code amount that could inhibit communication performance of the communication unit 304 in the code amount monitoring unit 1401, and for performing autonomous feedback control. Thus, use of the data communication apparatus according to the fifth embodiment enables easy reduction of bias of code amount that is generated locally by the autonomous feed back control, and realizing the smoothing of the code amount in a data communication apparatus that transmits multiple data streams in parallel on the network.

Note that the same effect of the autonomous feedback control can be achieved by the methods according to the third to the fifth embodiment, however, they are described as separate embodiments due to difference in load factors that inhibits communication, and difference in apparatuses and methods for monitoring and detection.

Furthermore, the detection method in the bandwidth monitoring unit, the CPU load monitoring unit, and the code amount monitoring unit in the third to the fifth embodiments may be polling or interrupt.

### Sixth Embodiment

The sixth embodiment according to the present invention is hereafter described with reference to the drawings.

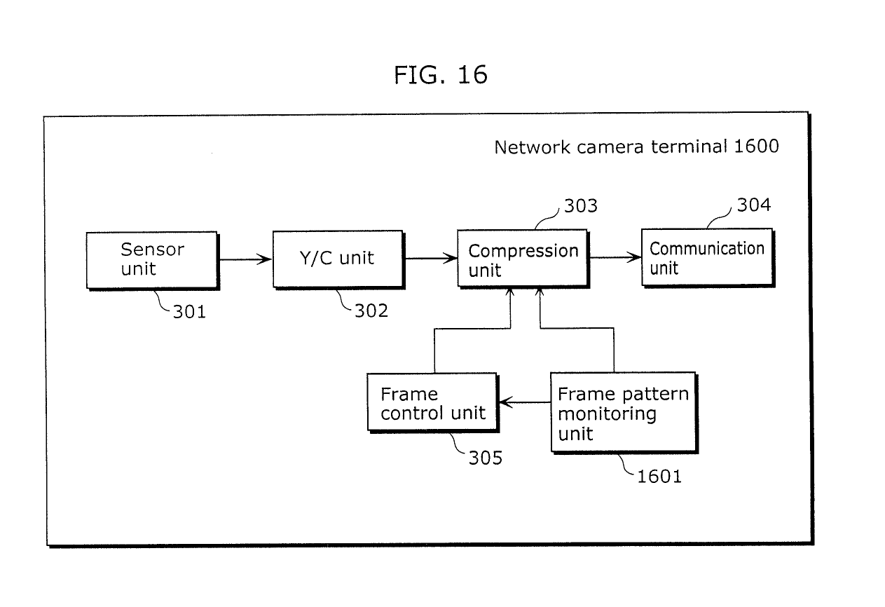

FIG. 16 is a functional block diagram showing the configuration of the network camera terminal 1600 according to the sixth embodiment, and is characterized by the frame pattern monitoring unit 1601 that monitors frame patterns of the coded frames generated in the same frame period in addition to the configuration described in the first embodiment.

The operation process of the network camera terminal 1600 according to the sixth embodiment is hereafter described.

First, the image information is inputted to the sensor unit 301. The sensor unit 301 digitally converts the image information and transmits the converted information to the Y/C unit 302. The Y/C unit 302 reads the digital data transmitted by the sensor unit 301, and resizes the data after the Y/C process, and transmits the data to the compression unit 303 as the Y/C data.

Next, the compression unit 303 receives the Y/C data from the Y/C unit 302, performs compression-coding such as MPEG, generates the coded frames, and transmits the coded frames to the communication unit 304. The communication unit 304 performs, for example, IP protocol process on the received coded frames, and transmits the processed coded frames to a communication partner via the network.

Here, the frame pattern monitoring unit 1601 monitors the code amount generated within the same frame period by the compression unit 303. For example, when the code amount increases by the coded frames unintentionally generated within the same frame period in the first to the fifth embodiments, the code amount exceeds the amount that can be transmitted by the communication unit 304. Thus, in the coded frames having large code amount, it is necessary to prevent the code amount from exceeding the code amount that can be communicated via the communication unit 304. Note that the frame pattern may also be the frame type.

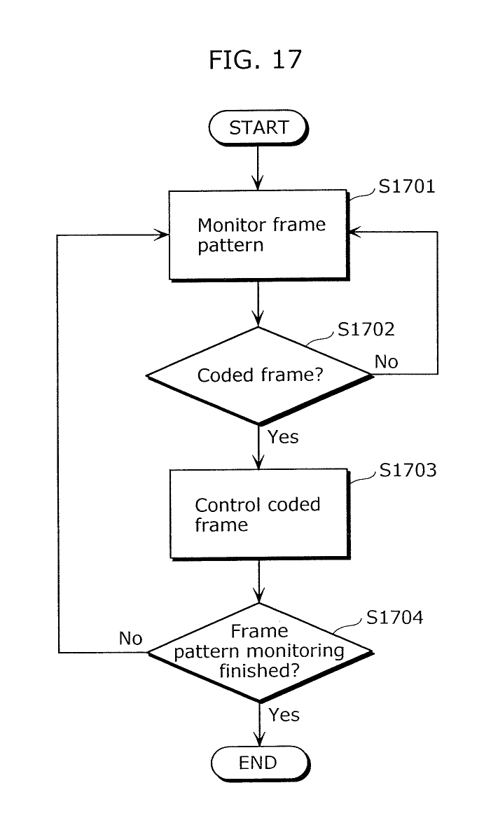

The process flow of the frame pattern monitoring unit 1601 is described with reference to FIG. 17. First, when the monitoring of the frame pattern starts, the frame pattern monitoring unit 1601 starts monitoring the frame pattern in the compression unit 303 (S1701).

When the coded frames having a large code amount is generated within the same frame period (Yes in S1702), the frame control unit 305 is notified, and the frame control unit 305 controls the compression unit 303 to generate the coded frames having small code amount (S1703). More specifically, the frame pattern monitoring unit 1601, for example, when an I-frame and an I-frame are simultaneously generated in different streams, performs processing such as changing one of the I-frame generated in either one of the streams to a P-frame.

Next, the termination of monitoring of the frame patterns is checked (S1704), and when the monitoring of the frame patterns continues (No in S1704), processing after monitoring of the frame pattern (S1701) is repeated.

On the other hand, when the monitoring of the frame patterns is terminated (Yes in S1704); the frame pattern monitoring process is terminated.

As described above, the effects achieved by the sixth embodiment are same as the effects achieved in the first to fifth embodiments, namely, facilitating reduction of bias of code amount that is generated locally, and realizing the smoothing of the code amount. However, in the first to fifth embodiments, there is a problem that the coded frames with large code amount that are unintentionally generated within the same frame period cannot be detected. For example, in the first embodiment, when a pattern for generating coded frames having large code amount is set upon setting the generation table by mistake, the coded frames cannot be detected due to the lack of a structure to control feedback. In the third to fifth embodiments, although there is an autonomous structure to control feedback, the feedback control does not function unless the target being monitored exceeds a fixed value. However, in the sixth embodiment, this problem can be solved by adding a frame pattern to the target being monitored by the feedback control structure, and detects the problem.

### Seventh Embodiment

The seventh embodiment according to the present invention is hereafter described with reference to the drawings.

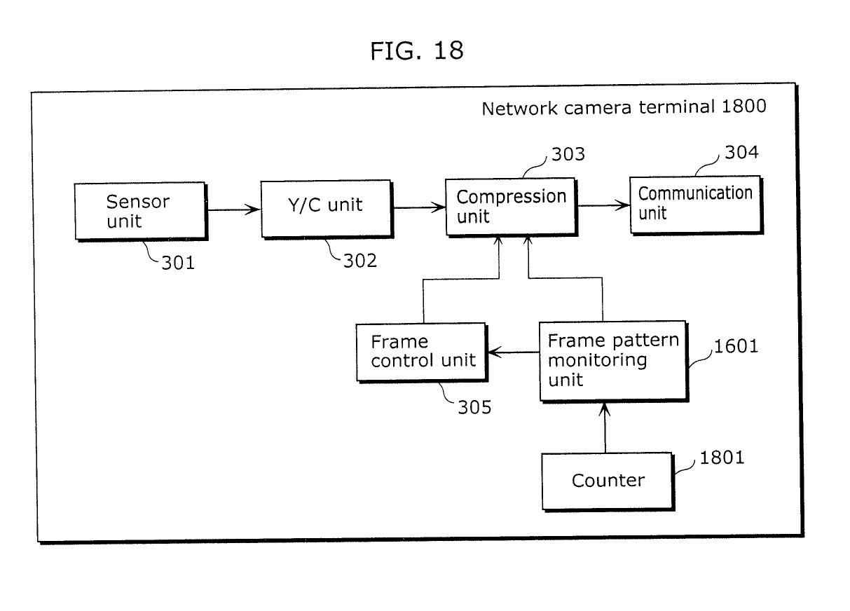

FIG. 18 is a functional block diagram showing the configuration of the network camera terminal 1800 according to the seventh embodiment, and is characterized by the counter 1801 that counts the number of successive generation of the coded frames generated in the compression unit 303 in addition to the configuration described in the sixth embodiment.

The operation process of the network camera terminal 1800 according to the seventh embodiment is hereafter described.

First, the image information is inputted to the sensor unit 301. The sensor unit 301 digitally converts the image information and transmits the converted information to the Y/C unit 302. The Y/C unit 302 reads the digital data transmitted by the sensor unit 301, and resizes the data after the Y/C process, and transmits the data to the compression unit 303 as the Y/C data.

Next, the compression unit 303 receives the Y/C data from the Y/C unit 302, performs compression-coding such as MPEG, generates the coded frame, and transmits the coded frames to the communication unit 304. The communication unit 304 performs, for example, IP protocol process on the received coded frames, and transmits the processed coded frames to a communication partner via the network.

Here, the frame pattern monitoring unit 1601 monitors the coded frames generated by the compression unit 303 within the same frame period, and counts the number of successive generation of the coding patterns having small code amount (for example, coded frames such as P-frame and B-frame that are difference information using the inter frame prediction), when such frames are detected successively. When the P-frames and the B-frames are successively generated, the coded image is gradually deteriorated. Thus, it is necessary to prevent the number of generation of coded frames which are difference information from exceeding a fixed value.

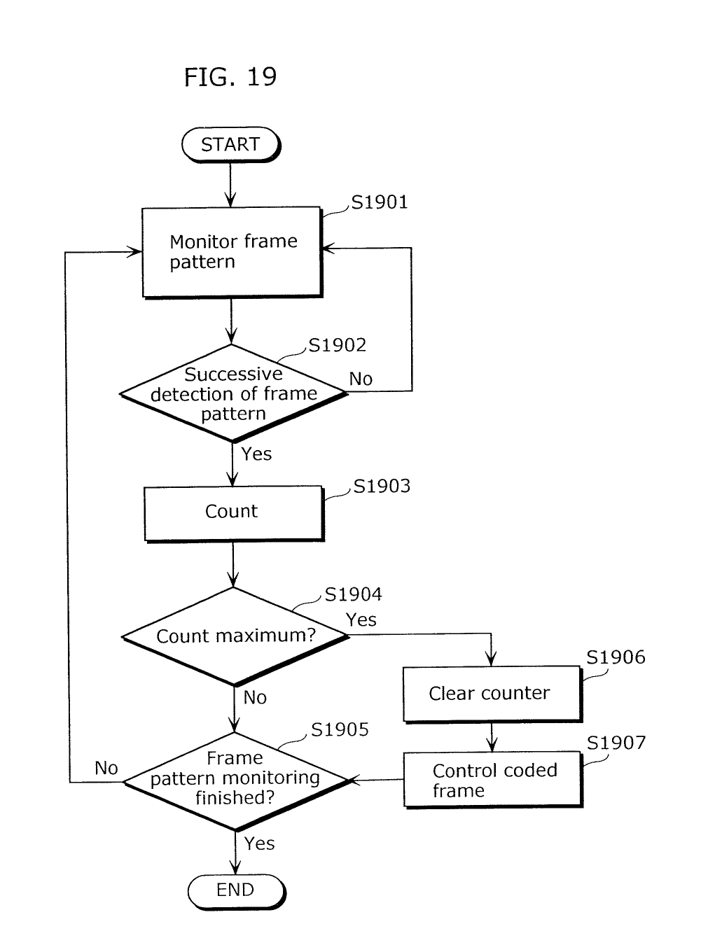

The count process flow of the counter 1801 according to the seventh embodiment is described with reference to FIG. 19.

First, when the monitoring of the frame pattern starts, the frame pattern monitoring unit 1601 starts monitoring the frame pattern in the compression unit 303 (S1901).

When the coded frames having small code amount (for example, P-frames and B-frames that includes difference information using the inter frame prediction) are successively generated within the same frame period (S1902), counting is performed by the counter 1801 (S1903).

Then it is checked whether the counted value exceeds the maximum value (S1904), and when the counted value reaches the maximum (Yes in S1904), the counter is cleared (S1906), and the frame control unit 305 performs control so that coded frames having large code amount (for example, I-frame that can be decoded using its own data and that has information of the original image) is generated (S1907). This control prevents the degradation in the decoded image.

In addition, when the counted value does not exceed the maximum value (NO in S1904), it is checked whether the frame pattern monitoring is terminated (S1905), and when the monitoring of the frame patterns continues (No in S1905), processing after monitoring of the frame pattern (S1901) is repeated. On the other hand, when the monitoring of the frame patterns is terminated (Yes in S1905), the frame pattern monitoring process is terminated.

As described above, the effect of the seventh embodiment is that the degradation of the decoded image is appropriately prevented by generating I-frame when the coded pattern having small code amount (for example, coded frames such as P-frames and B-frames that includes difference information using the inter frame prediction) and when the count value reaches the set maximum value.

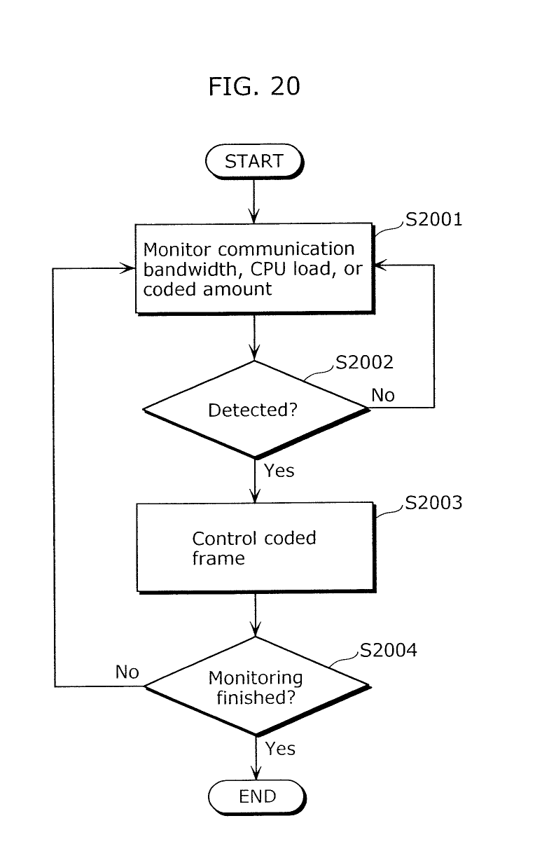

Note that in the network camera terminal according to the present invention, as shown in the flowchart in FIG. 20, the monitoring subject, i.e., the communication bandwidth, the CPU load rate, and code amount can be simultaneously monitored in combination (S2001).

In this case, when the monitoring subject is not detected in S2001 (No in S2002), the processing in S2001 is restarts.

On the other hand, when it is detected (Yes in S2002), coded frame is controlled (S2003).

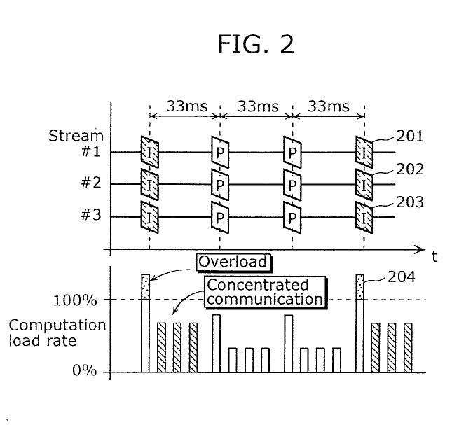

Note that when controlling the coded frames, instead of controlling that avoids generation of coded frames having large code amount, for example, an I-frame within the same frame as described in the first to fifth embodiments, may allow overlap of the I-frames. For example, as shown in FIG. 2, when three I-frames are detected, two I-frames are generated first, and after a loop, checked again in S2002. When it is detected (Yes in S2002), one I-frame is generated and goes through the loop. This process enables judging the limit load, the bandwidth and the CPU utilization rate that can perform communication, and allows effective use of the transmission capability.

### Eighth Embodiment

The eighth embodiment according to the present invention is hereafter described with reference to the drawings.

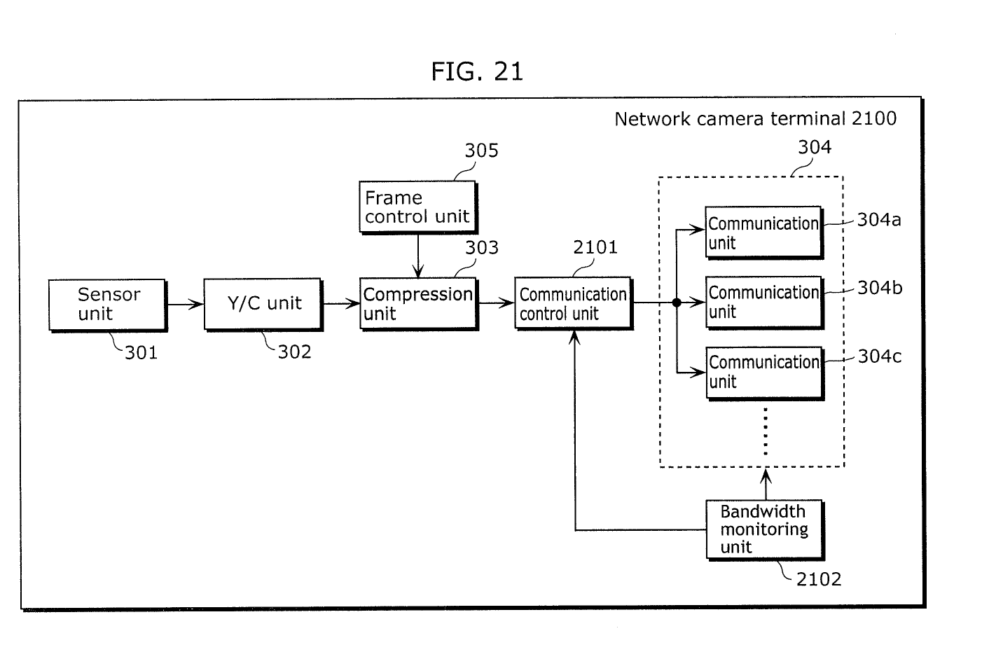

FIG. 21 is a functional block diagram showing the configuration of the network camera terminal 2100 according to the eighth embodiment, and is characterized by the communication unit 304 that includes multiple communication units 304a to 304c that packetizes the coded frames and communicates the packetized coded frames, the communication control unit 2101 that selects and controls the communication unit 304 to be used, and the bandwidth monitoring unit 2102 that monitors the communication bandwidth of the communication unit 304.

The operation process of the network camera terminal 2100 according to the eighth embodiment is hereafter described.

First, the image information is inputted to the sensor unit 301. The sensor unit 301 digitally converts the image information and transmits the converted information to the Y/C unit 302. The Y/C unit 302 reads the digital data transmitted by the sensor unit 301, and resizes the data after the Y/C process, and transmits the data to the compression unit 303 as the Y/C data.

Next, the compression unit 303 receives the Y/C data from the Y/C unit 302, performs compression-coding such as MPEG, and generates the coded frames.

Next, the bandwidth monitoring unit 2102 monitors a communication bandwidth of one of the communication unit being used among the multiple communication units 304a to 304c, and when the communication bandwidth exceeds the fixed amount, the bandwidth monitoring unit 2102 notifies the communication control unit 2101, and other communication unit that has light communication bandwidth is used.

As described above, in the network camera terminal according to the eighth embodiment, when multiple communication units are included, the communication bandwidth of the communication unit can be effectively used. Here, the communication unit may use wired communication such as the Ethernet (trademark) or the Power Line Communication (PLC), or wireless communication such as IEEE 802.11a/b/g or the Bluetooth.

### Ninth Embodiment

The ninth embodiment according to the present invention is hereafter described with reference to the drawings.

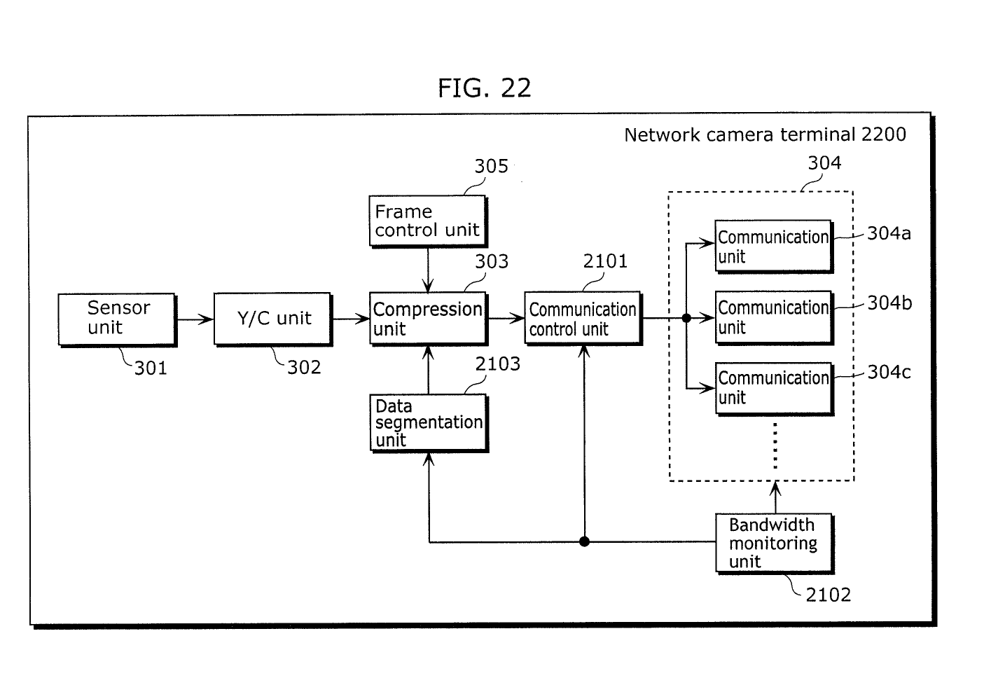

FIG. 22 shows the network camera terminal 2200 according to the ninth embodiment of the present invention, and the network camera terminal 2200 includes the data segmentation unit 2103 that segments the coded frames that has been generated by the compression unit 303, in addition to the configuration described in the eighth embodiment.

The operation process of the network camera terminal 2200 according to the ninth embodiment is hereafter described.

First, the image information is inputted to the sensor unit 301. The sensor unit 301 digitally converts the image information and transmits the converted information to the Y/C unit 302. The Y/C unit 302 reads the digital data transmitted by the sensor unit 301, and resizes the data after the Y/C process, and transmits the data to the compression unit 303 as the Y/C data.

Next, the compression unit 303 receives the Y/C data from the Y/C unit 302, performs compression-coding such as MPEG, and generates the coded frames.

Next, the communication bandwidths of the multiple communication units 304a to 304c are monitored by the bandwidth monitoring unit 2102. Next, the coded frames generated by the compression unit 303 are segmented by the data segmentation unit 2103 according to the communication bandwidth being monitored. Next, the segmented coded frames are allocated to the communication units 304 by the data communication control unit 2101, and the segmented coded frames are communicated.

As described above, according to the ninth embodiment, when there are multiple communication units, communication bandwidths of all communication units can be effectively used. The eighth embodiment had a problem that only one communication unit can be used at one time even when there are multiple communication units. However, the ninth embodiment can solve the problem.

### Tenth Embodiment

The tenth embodiment according to the present invention is hereafter described with reference to the drawings.

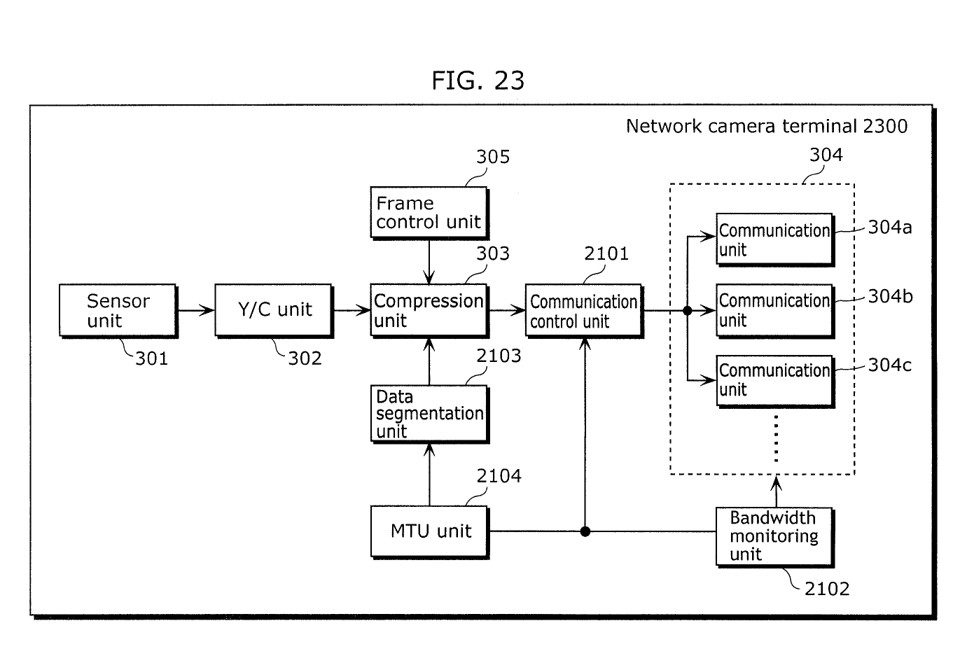

FIG. 23 is a functional block diagram showing the configuration of the network camera terminal 2300 according to the tenth embodiment, and includes, in addition to the configuration shown in the ninth embodiment, the MTU unit 2104 that judges the size of the Maximum Transmission Unit (MTU) in the multiple communication units 304a to 304c, and segments the data by the sizes of the MTU.

The operation process of the network camera terminal 2300 according to the tenth embodiment is hereafter described.

First, the image information is inputted to the sensor unit 301. The sensor unit 301 digitally converts the image information and transmits the converted information to the Y/C unit 302. The Y/C unit 302 reads the digital data transmitted by the sensor unit 301, and resizes the data after the Y/C process, and transmits the data to the compression unit 303 as the Y/C data. Next, the compression unit 303 receives the Y/C data from the Y/C unit 302, performs compression-coding such as MPEG, and generates the coded frames.

Next, the bandwidth monitoring unit 2102 monitors the communication bandwidth of the multiple communication units 304. Next, the coded frames generated by the compression unit 303 is segmented by the MTU unit 2104 and the data segmentation unit 2103 in the MTU size of the communication unit 304 according to the monitored communication bandwidth. Next, the segmented coded frames are allocated to the communication units 304 by the data communication control unit 2101, and the segmented coded frames are communicated.

As described above, the network camera terminal according to the tenth embodiment can most effectively use all the communication bandwidth simultaneously since data transmission can be performed in the MTU size that matches all communication units 304, when multiple communication units 304 are included. The eighth and the ninth embodiment have a problem that even when multiple communication units are included, the communication bandwidth of the communication unit 304 is not effectively used since the data is not transmitted in the MTU size of the communication unit 304. The tenth embodiment can solve the problem.

Note that the format and the MTU size (Ether, PLC, Wi-Fi and others) of each communication media are the maximum frame length of each communication unit, and for example, 1500 bytes in the case of the Ether/IEEE802.3, 64 KB in the case of PLC, and 2304 bytes in the case of the Wi-Fi/IEEE802.11a/b/g.

Furthermore, the compression unit in the network camera terminal according to each embodiment may perform compression-coding at different multiple bit rates. In addition, the compression methods used for coding in the compression unit may be the MPEG-2, the MPEG-4, or the H.264. Furthermore, the compression unit may perform compression-coding at multiple different frame rates.

Furthermore, the network interface in the communication unit may be a wired communication such as the Ethernet™ or the PLC, or wireless communication such as the wireless LAN and the Bluetooth. Furthermore, the communication unit may multiplex the image signals or the audio signals in the communication unit and transmits the multiplexed signals on the network.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The data communication apparatus according to the present invention may be applied to a network camera device that communicates a compressed image and audio in parallel and in real time to multiple communication terminals such as personal computers, PDAs, and mobile phones that respectively use images having different resolutions. The data communication apparatus may also be applied to a device other than a network camera, which performs real-time streaming.

What is claimed is:

1. A data communication apparatus that generates coded frames from an inputted image or audio signal through compression coding and communicates data streams to communication terminals in parallel through a network, the data streams including the generated coded frames, said data communication apparatus comprising:
a sensor unit configured to take image or audio information;
a compression unit configured to compression-code the image or the audio signal that has been taken by said sensor unit and to generate coded frames for each frame period;
a frame control unit configured to control types of the coded frames generated by said compression unit, the types of the coded frames including a first type and a second type, and the coded frame of the first type having larger code amount than the coded frame of the second type; and
a communication unit configured to communicate the coded frames compression-coded by said compression unit to the communication terminals in parallel through the network,
wherein said frame control unit is configured to control the types of the coded frames respectively corresponding to data streams, such that the coded frames of the first type are not generated within a same frame period.

2. The data communication apparatus according to claim 1,
wherein said frame control unit includes a generation table holding unit configured to store a generation table indicating a combination patterns of the types of coded frames generated by said compression unit, and
said frame control unit is configured to control, according to the combination patterns the types of coded frames respectively corresponding to the data streams, such that the coded frames of the first type with large code amount are not generated within the same frame period.

3. The data communication apparatus according to claim 1,
wherein said frame control unit includes decrement counters respectively corresponding to the data streams, and said frame control unit is configured to control the types of the coded frames each of which corresponds to each data stream using counter values of said decrement counter for modifying the generation rate of the coded frames.

4. The data communication apparatus according to claim 3,
wherein said frame control unit is configured to control the types of the coded streams respectively corresponding to the data stream such that the coded frames of the first type are not generated within the same frame period by adjusting initial values of said decrement counters for each data stream so that the initial values are not to be equal, or by adding or subtracting counter values when the counter values of the decrement counters are equal to one another.

5. The data communication apparatus according to claim 1, further comprising
a bandwidth monitoring unit configured to monitor a communication bandwidth of said communication unit,
wherein said bandwidth monitoring unit is configured to notify said frame control unit when the communication bandwidth exceeds a predetermined amount, and
said frame control unit is configured to perform control such that a coded frame of the second type is generated when said frame control unit has received the notification from said bandwidth monitoring unit.

6. The data communication apparatus according to claim 1, further comprising
a CPU load monitoring unit configured to monitor a CPU load rate,
wherein said CPU load monitoring unit is configured to notify said frame control unit when the CPU load rate exceeds a predetermined rate, and
said frame control unit is configured to perform control such that a coded code of the second type is generated when said frame control unit has received the notification from said CPU load monitoring unit.

7. The data communication apparatus according to claim 1, further comprising
a code amount monitoring unit configured to monitor code amount of the generated coded frames,
wherein said code amount monitoring unit is configured to notify said frame control unit when the code amount of the generated coded frames exceeds a predetermined amount, and
said frame control unit is configured to perform control such that a coded frame of a type with small code amount is generated when said frame control unit receives the notification.

8. The data communication apparatus according to claim 1, further comprising
a frame pattern monitoring unit configured to monitor the types of coded frame generated in said compression unit,
wherein said frame control unit is configured to perform control such that a coded frame of the second type is generated when a result of monitoring by said frame pattern monitoring unit indicates generation of coded frames of the first type overlaps within the same frame period in the data streams.

9. The data communication apparatus according to claim 8, further comprising
a counter that counts the number of successive generation of the coded frames of the second type generated in said compression unit,
wherein said frame pattern monitoring unit is configured to notify said frame control unit when the number of the successive generation of the coded frames of the second type exceeds a predetermined amount, and
said frame control unit is configured to perform control such that a coded frame of the first type is generated while preventing generation of the coded frames of the first type from being generated within the same frame period when said frame control unit receives the notification.

10. The data communication apparatus according to claim 1,
wherein said communication unit includes different types of data communication units,
said data communication apparatus further comprises:
a communication control unit configured to perform control that allows use of said communication unit; and
a bandwidth monitoring unit configured to monitor a communication bandwidth of said communication unit,
said communication control unit is configured to select another data communication unit included in said communication unit when a communication bandwidth of said data communication unit in use that is monitored by said bandwidth monitoring unit exceeds a predetermined amount, and
said selected data communication unit is configured to communicate the coded frames to the communication terminals.

11. The data communication apparatus according to claim 10, further comprising
a data segmentation unit configured to segment the coded frame,
wherein said data segmentation unit segments the coded frame when a result of monitoring by said bandwidth monitoring unit indicates that a communication traffic is congested in said bandwidth monitoring unit, and
said communication control unit is configured to allocate the segmented coded frame to said data communication units, and communicate the segmented coded frames to the communication terminals.

12. The data communication apparatus according to claim 11, further comprising
an MTU unit configured to determine a size of Maximum Transmission Unit (MTU) optimal for the network in which the coded frame are communicated,
wherein said data segmentation unit is configured to segment the coded frame into the segmented coded frames at the MTU size that has been determined as optimal by said MTU unit, and
said communication unit is configured to communicate the segmented coded frame.

13. The data communication unit according to claim 7,
wherein said frame control unit is configured to gradually adjust code amount using a combination of the types of coded frames generated within the same frame period.

14. A data communication method for generating coded frames from an inputted image or audio signal through compression coding and communicates data streams to communication terminals in parallel through a network, the data streams including the generated coded frames, said data communication method comprising:
compressing the image or the audio signal that has been taken by the sensor unit and to generate coded frames for each frame period;
controlling of the coded frames generated by the compression unit, the types of the coded frames including a first type and a second type, and the coded frame of the first type having larger code amount than the coded frame of the second type; and
communicating the coded frames compression-coded by the compression unit to the communication terminals in parallel through the network,
wherein said controlling includes control of the types of the coded frames respectively corresponding to data streams, such that the coded frames of the first type are not generated within a same frame period.

15. The data communication method according to claim 14,
wherein said controlling includes holding of a generation table indicating a combination patterns of the types of coded frames generated by said compression unit, and
controlling is performed, according to the combination patterns the types of coded frames respectively corresponding to the data streams, such that the coded frames of the first type with large code amount are not generated within the same frame period.

16. The data communication method according to claim 14,
wherein said controlling includes decrement counting respectively corresponding to the data streams, and the frame control unit is configured to control the types of the coded frames each of which corresponds to each data stream using counter values of the decrement counter for modifying the generation rate of the coded frames.
